(19) United States
(12) Patent Application Publication
(10) Pub. No.: US 2025/0092274 A1
(43) Pub. Date: Mar. 20, 2025

(54) INK SET FOR TEXTILE PRINTING

(71) Applicant: RISO KAGAKU CORPORATION, Tokyo (JP)

(72) Inventors: Akiko HAYASHI, Tokyo (JP); Kokoro KINOE, Tokyo (JP); Shinichiro SHIMURA, Tokyo (JP); Yuki URANO, Tokyo (JP); Shotaro KON, Tokyo (JP); Takahisa YAMAZAKI, Tokyo (JP); Takumi MATSUDA, Tokyo (JP)

(21) Appl. No.: 18/883,510

(22) Filed: Sep. 12, 2024

(30) Foreign Application Priority Data
Sep. 14, 2023 (JP) 2023-149074

(51) Int. Cl. C09D 11/40; C09D 11/102; C09D 11/107; C09D 11/108; D06P 1/52; D06P 5/30

(52) U.S. Cl. CPC C09D 11/40; C09D 11/102; C09D 11/107; C09D 11/108; D06P 1/5221; D06P 1/5257; D06P 1/5285; D06P 5/30

(57) ABSTRACT

Provided is an ink set for textile printing including a white inkjet ink that includes a white pigment, resin particles A which have a film elongation of 1,000% or more, and resin particles B which have a film elongation of less than 1,000% and are ionic resin particles having an average particle size of 150 nm or less; and a non-white inkjet ink that includes a non-white pigment and resin particles C which have a film elongation of 500% or more and a resin skeleton different from those of the resin particles A and the resin particles B.

### CROSS REFERENCE TO RELATED APPLICATIONS

This application is based upon and claims the benefit of priority from the prior Japanese Patent Application No. 2023-149074, filed on Sep. 14, 2023, the entire contents of which are incorporated by reference herein.

### BACKGROUND OF THE INVENTION

### Field of the Invention

Embodiments of the present invention relate to an ink set for textile printing.

### Description of the Related Art

Among various methods for textile-printing images like text, pictures, or designs onto fabrics, such as woven fabrics, knitted fabrics, and nonwoven fabrics, inkjet textile printing methods are now attracting considerable attention in addition to other methods like screen textile printing and roller textile printing.

Compared to fabrics having a light color such as white, images formed on fabrics having a dark color such as black tend to be less visible. JP 2009-30014 A describes a method where, after a fabric having a dark color such as black is coated with a pretreatment agent containing a polyvalent metal salt, an ink containing a white pigment is printed to form a white image, thus forming a desired image thereon. JP 2009-30014 A also describes applying a pretreatment agent and then performing a heat treatment.

### BRIEF SUMMARY OF THE INVENTION

When a non-white image is formed on a white image, the white image is held on the fabric surface while the non-white image is held near the surface of the white image, and thus the color development of the image can be enhanced on the surface of the fabric substrate. In this case, it is expected that inks are designed in such a manner that white pigments and non-white pigments remain on the surface of fabric substrates. In the case of layered printing with multiple types of inks, there is a phenomenon where in a drying process of removing non-volatile components, ink coating films break into small pieces and crack, and the color development tends to decrease. In JP 2009-30014 A, after a pretreatment agent is applied, a heat treatment is performed, but this does not sufficiently prevent the penetration of white pigments and non-white pigments into fabric substrates, and there is room for improvement of the color development from other aspects.

One embodiment of the present invention relates to an ink set for textile printing, including a white inkjet ink that includes a white pigment, resin particles A which have a film elongation of 1,000% or more, and resin particles B which have a film elongation of less than 1,000% and are ionic resin particles having an average particle size of 150 nm or less; and a non-white inkjet ink that includes a non-white pigment and resin particles C which have a film elongation of 500% or more and a resin skeleton different from those of the resin particles A and the resin particles B.

### DETAILED DESCRIPTION OF THE INVENTION

Embodiments of the present invention are described below in detail, but needless to say, the present invention is not limited to these embodiments, and various modifications and alterations are possible.

An ink set according to one embodiment is an ink set for textile printing, including a white inkjet ink that includes a white pigment, resin particles A which have a film elongation of 1,000% or more, and resin particles B which have a film elongation of less than 1,000% and are ionic resin particles having an average particle size of 150 nm or less; and a non-white inkjet ink that includes a non-white pigment and resin particles C which have a film elongation of 500% or more and a resin skeleton different from those of the resin particles A and the resin particles B.

By using this ink set, it becomes possible to produce a printed textile item having an image excellent in color development.

In the present disclosure, the ink set for textile printing is also referred to simply as an ink set. Resin particles A that have a film elongation of 1,000% or more are also referred to as resin particles A. Resin particles B that have a film elongation of less than 1,000% and are ionic resin particles having an average particle size of 150 nm or less are also referred to as resin particles B. Resin particles C that have a film elongation of 500% or more and have a resin skeleton different from those of the resin particles A and resin particles B are also referred to as resin particles C. A white inkjet ink is also referred to as a white ink (W), and a non-white inkjet ink is also referred to as a non-white ink (C).

Factors that influence the color development of printed textile items obtained by using the white ink and non-white ink are thought to be, but are not limited to, immiscibility between the white ink and the non-white ink on the surface of substrates after ink application, extensibility of non-white images, and concealability of white images.

Regarding immiscibility between the white ink and the non-white ink, when the non-white ink (C) is applied to a white image formed with the white ink (W), if the miscibility between the white ink (W) and the non-white ink (C) is high, the inks mix together, resulting in a decrease in the color development of a non-white image. Although not bound by theory, it is presumed that the non-white ink (C) acts as follows.

Since the resin particles C contained in the non-white ink (C) have a resin skeleton different from those of the resin particles A and resin particles B contained in the white ink (W), miscibility between the white ink (W) and the non-white ink (C) is suppressed on the surface of a substrate. A non-white pigment thus remains on the surface of the substrate, and a non-white image having high color development can be formed.

Note that in the present disclosure, the difference in resin skeletons between two resins means that monomer units constituting the resins, or reaction raw materials of the resins, are not completely identical.

Although the extensibility of the non-white image is not bound by theory, it is presumed that the non-white ink (C) acts as follows.

Since the non-white ink (C) contains the resin particles C having a film elongation of 500% or more, it is easy for the non-white ink (C) to spread in the X and Y axes directions through heating and pressurization, and a non-white image formed has high extensibility.

Consequently, the non-white image is less likely to break and has excellent color development.

As described below, since the white ink (W) contains the resin particles A, it is easy for the white ink (W) to spread in the X and Y axes directions through heating and pressurizing, and a white image formed has high extensibility. When the extensibility of a non-white image formed on a white image is low and the non-white image cannot follow the extension of the white image, a break occurs in the non-white image, and consequently, the color development of the non-white image decreases.

As regards concealability of the white image, more specifically, uniformity and whiteness of the white image can be considered. Since the white image formed with the white ink (W) is excellent in uniformity and whiteness, it contributes to the improvement of color development of printed textile items. Although not bound by theory, it is presumed that the white ink (W) acts as follows.

Since the resin particles A contained in the white ink (W) have a film elongation of 1,000% or more, it is easy for the white ink (W) to elongate and spread well in the XY axis direction through heating and pressurization, and distribution of the ink can be easily homogenized even when a substrate with a visible nap is used. Thus, it is easy to enhance the uniformity of the white image.

Since the resin particles B contained in the white ink (W) are small particles having an average particle size of 150 nm or less, it is easy for the white ink (W) to enter gaps between fibers of the substrate. Since the resin particles B are ionic, they agglomerate when coming into contact with a pretreatment liquid containing an aggregating agent such as a polyvalent metal salt, and are capable of exerting a filling effect to suppress the penetration of ink components into the substrate. Consequently, the whiteness of the white image can be enhanced.

### White Inkjet Ink

The white ink (W) contains a white pigment, the resin particles A having a film elongation of 1,000% or more, and the resin particles B having a film elongation of less than 1,000% and being ionic resin particles having an average particle size of 150 nm or less.

The white ink (W) contains the white pigment as a color material. The white ink can be used to form an image exhibiting white color by containing the white pigment.

An example of the white pigment is a white inorganic pigment such as titanium oxide, zinc oxide, zinc sulfide, antimony oxide, and zirconium oxide. Among these, titanium oxide is preferably used from the viewpoint of concealability. The average particle size of titanium oxide is preferably 100 nm or more from the viewpoint of concealability, and preferably 600 nm or less from the viewpoint of jetting stability.

As the white pigment, a pigment dispersion in which a pigment has been previously dispersed with a pigment dispersant may be used. A pigment dispersion that has been dispersed with a pigment dispersant described below may be used.

For the white pigment, one type may be used, or a combination of two or more types may be used.

The amount of the white pigment is preferably within a range from 1% to 30% by mass relative to the total amount of the white ink (W), more preferably from 3% to 20% by mass, and even more preferably from 5% to 15% by mass, from the viewpoint of concealability and the like.

In order to stably disperse a white pigment in the white ink (W), a pigment dispersant typified by polymeric dispersants and surfactant-type dispersants can be used.

Commercial examples of polymeric dispersants include the TEGO Dispers series such as TEGO Dispers 740W, TEGO Dispers 750W, TEGO Dispers 755W, TEGO Dispers 757W, and TEGO Dispers 760W manufactured by Evonik Japan Co., Ltd., the Solsperse series such as Solsperse 20000, Solsperse 27000, Solsperse 41000, Solsperse 41090, Solsperse 43000, Solsperse 44000, and Solsperse 46000 manufactured by The Lubrizol Corporation, the Joncryl series such as Joncryl 57, Joncryl 60, Joncryl 62, Joncryl 63, Joncryl 71, and Joncryl 501 manufactured by BASF Japan Ltd., DISPERBYK-102, DISPERBYK-185, DISPERBYK-190, DISPERBYK-193, and DISPERBYK-199 manufactured by BYK-Chemie Japan K.K., and Polyvinylpyrrolidone K-30 and Polyvinylpyrrolidone K-90 manufactured by DKS Co. Ltd. (all product names).

Examples of surfactant-type dispersants include anionic surfactants including the DEMOL series such as DEMOL P, DEMOL EP, DEMOL N, DEMOL RN, DEMOL NL, DEMOL RNL, and DEMOL T-45 manufactured by Kao Corporation, and nonionic surfactants including the EMULGEN series such as EMULGEN A-60, EMULGEN A-90, EMULGEN A-500, EMULGEN B-40, EMULGEN L-40, and EMULGEN 420 manufactured by Kao Corporation (all product names).

For the pigment dispersant described above, one type may be used, or a combination of two or more types may be used.

When a pigment dispersant is used, the blend amount of the pigment dispersant in the white ink (W) varies depending on the type and is not particularly limited, but in general is preferably within a range of 0.005 to 0.5 as a mass ratio of the active component relative to a value of 1 for the pigment.

The white ink (W) can contain the resin particles A.

The resin particles A preferably are resin particles that are dispersible in an aqueous solvent. It is preferable that the resin particles A can be dispersed in water without being dissolved in water to form an oil-in-water (O/W) emulsion.

The resin particles A are preferably contained in a dispersed state as resin particles in the white ink (W). The resin particles A can be blended as a water dispersion of resin particles in the production of the white ink (W).

The resin particles A may have functional groups of the resin existing at the surface of resin particles as in a self-emulsifying resin. The resin particles A may have been subjected to a surface treatment such as adhering a dispersant to resin particle surfaces.

The resin particles A may be anionic, cationic, nonionic, or amphoteric, for example, but are preferably anionic or nonionic and more preferably anionic.

The anionic resin particles may have anionic functional groups of the resin existing at the surface of resin particles as in a self-emulsifying resin. The anionic resin particles may have been subjected to a surface treatment such as adhering an anionic dispersant to resin particle surfaces. Typical examples of anionic functional groups include carboxy groups, sulfo groups, sulfino groups, sulfuric acid ester groups, phosphoric acid groups, phosphoric acid ester groups, phosphorous acid groups, and phosphorous acid ester groups. An example of the anionic dispersing agent is an anionic surfactant.

The non-ionic resin particles may have non-ionic functional groups of the resin existing on the surface of resin particles as in a self-emulsifying resin. The non-ionic resin particles may have been subjected to a surface treatment such as adhering a non-ionic dispersant to resin particle surfaces. Typical examples of non-ionic functional groups include polyoxyalkylene glycol groups and hydroxy groups. An example of the non-ionic dispersant is a non-ionic surfactant.

The film elongation of the resin particles A is 1,000% or more, and from the viewpoint of further improving the uniformity of white images, is preferably 1,100% or more, and more preferably 1,200% or more. The film elongation of the resin particles A may be 2,000% or less, 1,800% or less, 1,700% or less. The film elongation of the resin particles A may be within a range from 1,000% to 2,000%, from 1,100% to 1,800%, or from 1,200% to 1,700%.

In this description, the film elongation of resin particles may be measured according to the following procedure. First, a water dispersion of resin particles is applied to a polytetrafluoroethylene sheet in such a manner that the film thickness after drying is 500 m, and dried at 23° C. for 15 hours, further at 80° C. for 6 hours, and at 120° C. for 20 minutes, and then the resulting film is peeled off from the sheet to form a resin film. The resin film is cut into columns having a width of 2 cm and a length of 4 cm to form resin film specimens. Using a tensile testing machine, at a measurement temperature of 20° C. and a measurement speed of 200 mm/min, a resin film specimen is stretched to measure the length of the resin film specimen until it breaks, and a value expressed as a percentage of the length relative to the original length is set as the film elongation. A tensile testing machine RTC-1225A (manufactured by ORIENTEC CO., LTD.) can be used as a tensile testing machine.

The average particle size of the resin particles A is preferably 1.5 times or more that of the resin particles B. The average particle size of the resin particles A may be 8 times or less that of the resin particles B. The average particle size of the resin particles A may be within a range of 1.5 to 8 times relative to the average particle size of the resin particles B. Since the average particle size of the resin particles A is larger than that of the resin particles B, the resin particles A are likely to remain on aggregated resin particles B, the filling effect is likely to be better exerted by the resin particles B, and the whiteness of white images is likely to be further improved.

The average particle size of the resin particles A is preferably larger than 150 nm, and more preferably 160 nm or more. As the average particle size of the resin particles A is larger, the contact area between the resin particles A and a pretreatment liquid becomes smaller, the bond between the resin particles is less affected by the pretreatment liquid, and a more uniform ink film can be formed. The average particle size of the resin particles A may be 160 nm or more. The average particle size of the resin particles A may be 600 nm or less, 500 nm or less, or 300 nm or less. The average particle size of the resin particles A may be larger than 150 nm and 600 nm or less, within a range from 160 to 500 nm, or from 160 to 300 nm, for example.

In this description, the average particle size of resin particles is the median diameter on a volume basis in a particle size distribution measured using a dynamic light scattering method. The particle size distribution of resin particles can be measured at 25° C. using a measurement sample in which a dispersion of resin particles is diluted with water to a resin particle concentration of 0.5% by mass. A nanoparticle analyzer nanoPartica SZ-100 (manufactured by Horiba, Ltd.) can be used as a dynamic light scattering type particle size distribution measuring device, for example.

Note that it is preferable to measure the average particle size of resin particles in a state of a resin particle dispersion as a raw material before ink is prepared because the influence of a coloring material can be eliminated, and the measured value can be used as the average particle size of resin particles.

In terms of the type of resin particles A, the use of a resin that forms a transparent coating film is preferred.

Examples of the type of resin particles A include conjugated diene-based resins such as styrene-butadiene copolymers, methyl methacrylate-butadiene copolymers, and vinyl chloride-vinyl acetate copolymers; acrylic-based resins such as acrylate ester polymers and methacrylate ester polymers, or copolymers of these compounds with styrene or the like; vinyl-based resins such as ethylene-vinyl acetate copolymers, or functional group-modified resins in which a carboxyl group or the like of any of these resins has been modified with a functional group-containing monomer; and resin particles such as melamine resins, urea resins, polyurethane resins, polyester resins, polyolefin resins, silicone resins, polyvinyl butyral resins, and alkyd resins. Resin particles containing one of these resins may be used, and hybrid resin particles may also be used.

For the resin particles A, one type may be used alone, and two or more types may be used in combination.

Commercial examples of the water dispersion of resin particles A include “Impranil DLP”, “Impranil DLP-R”, “Impranil DLV”, “Impranil DLI”, “Impranil 1016”, “Impranil 1116”, “Impranil DLS”, “Impranil DL 1537”, “Impranil DL 1554”, “Impranil DL 1380”, “Impranil LP CGL 105”, “Impranil DLN-SD”, “Impranil LP DSB 1069”, and “Impranil DLN-W50”, manufactured by Sumika Covestro Urethane Co., Ltd., and “SUPERFLEX E2000”, “SUPERFLEX 740”, “SUPERFLEX 500M”, and “SUPERFLEX 300”, manufactured by DKS Co. Ltd. (all product names).

The resin particles A preferably contain polyurethane resin particles from the viewpoint of film elongation.

The amount (solid content) of the resin particles A in the white ink (W) is preferably 5% by mass or more, more preferably 8% by mass or more, and even more preferably 10% by mass or more. The amount (solid content) of the resin particles A in the white ink (W) is preferably 25% by mass or less, more preferably 20% by mass or less, and even more preferably 15% by mass or less. The amount (solid content) of the resin particles A in the white ink (W) is preferably, for example, within a range from 5% to 25% by mass, and more preferably from 8% to 15% by mass.

The white ink (W) contains the resin particles B.

The resin particles B preferably are resin particles that are dispersible in an aqueous solvent. It is preferable that the resin particles B can be dispersed in water without being dissolved in water to form an oil-in-water (O/W) emulsion.

The resin particles B are preferably contained in a dispersed state as resin particles in the white ink (W). The resin particles B can be blended as a water dispersion of resin particles in the production of the white ink (W).

The resin particles B are preferably ionic. The resin particles B may be anionic, cationic, or amphoteric, but are more preferably anionic.

The anionic resin particles are a negatively charged dispersible resin in which the particle surfaces carry a minus charge. The anionic resin particles may have anionic functional groups of the resin existing at the surface of particles as in a self-emulsifying resin. The anionic resin particles may have been subjected to a surface treatment such as adhering an anionic dispersant to resin particle surfaces. Examples of anionic functional groups include carboxy groups, sulfo groups, sulfino groups, sulfuric acid ester groups, phosphoric acid groups, phosphoric acid ester groups, phosphorous acid groups, and phosphorous acid ester groups. An example of the anionic dispersing agent is an anionic surfactant.

The film elongation of the resin particles B is less than 1,000%. The film elongation of the resin particles B may be 800% or less and may be 600% or less. The film elongation of the resin B may be 100% or more and may be 200% or more. The film elongation of the resin particles B may be, for example, within a range of 100% to 800%, or of 200% to 600%.

The average particle size of the resin particles B is preferably 150 nm or less.

The average particle size of the resin particles B is more preferably 120 nm or less, even more preferably 100 nm or less, and still more preferably 80 nm or less. As the average particle size of the resin particles B is smaller, the contact area with a pretreatment liquid tends to be larger, and the reactivity with the pretreatment liquid can be higher.

The average particle size of the resin particles B is preferably 10 nm or more, more preferably 30 nm or more, and even more preferably 50 nm or more. For example, the average particle size of the resin particles B is preferably within a range from 10 to 150 nm, more preferably from 30 to 120 nm, even more preferably from 50 to 100 nm, and still more preferably from 50 to 80 nm.

The charge density of the resin particles B is preferably 10 μeq/g or more.

From the viewpoint of further improving the whiteness of white images, the charge density of the resin particles B is more preferably 60 μeq/g or more, and even more preferably 90 μeq/g or more. Generally, as the charge density gets higher, resin particles tend to depend on electrostatic repulsion rather than solvation for its dispersion stabilization. When the charge density of the resin particles B is 60 μeq/g or more, salting out tends to occur more easily when the resin particles B come into contact with a pretreatment liquid, and a filling effect is likely to be exerted even on a substrate having many gaps between fibers, thereby easily obtaining a higher degree of whiteness.

The charge density of the resin particles B is preferably 500 μeq/g or less, more preferably 300 μeq/g or less, and even more preferably 200 μeq/g or less. For example, the charge density of the resin particles B is preferably within a range from 10 to 500 μeq/g, more preferably from 60 to 300 μeq/g, and even more preferably from 90 to 200 μeq/g.

In this description, the charge density of resin particles is a charge density measured using a streaming potential method. The charge density of resin particles is an amount of charge per solid content of a water dispersion of the resin particles (unit: eq/g).

Specifically, while a diluted solution obtained by diluting a water dispersion of resin particles to be measured 100 fold with water is titrated with a 0.0025 N poly(diallyldimethylammonium chloride) solution, a reaction end point at which the flow potential of the diluted solution reaches 0 V is measured, and the total amount of charge for the diluted solution can be determined from the amount of the 0.0025 N poly(diallyldimethylammonium chloride) solution used in reaching this reaction end point.

The value obtained by dividing this total amount of charge for the diluted solution by the solid content of the resin particles contained in the diluted solution is the charge density of the resin particles (eq/g).

For example, a colloid particle charge meter (such as “Model CAS” manufactured by AFG Analytic GmbH) or the like can be used as the charge density measurement device.

In terms of the type of resin particles B, the use of a resin that forms a transparent coating film is preferred.

Examples of the type of resin particles B include conjugated diene-based resins such as styrene-butadiene copolymers, methyl methacrylate-butadiene copolymers, and vinyl chloride-vinyl acetate copolymers; acrylic-based resins such as acrylate ester polymers and methacrylate ester polymers, or copolymers of these compounds with styrene or the like; vinyl-based resins such as ethylene-vinyl acetate copolymers, or functional group-modified resins in which a carboxyl group or the like of any of these resins has been modified with a functional group-containing monomer; and resin particles such as melamine resins, urea resins, polyurethane resins, polyester resins, (oxidized)polyolefin resins, silicone resins, polyvinyl butyral resins, and alkyd resins. Resin particles containing one of these resins may be used, and hybrid resin particles may also be used.

For resin particles B, one type may be used alone, and two or more types may be used in combination.

Commercial examples of the water dispersion of the resin particles B include “SUPERFLEX E420”, “SUPERFLEX 150HS”, “SUPERFLEX 460”, and “SUPERFLEX 470”, manufactured by DKS Co. Ltd., “DAOTAN TW6450”, “DAOTAN TW6460”, and “DAOTAN VTW1262”, manufactured by DAICEL-ALLNEX LTD., “ELITEL KT9204” and “ELITEL KT8803” manufactured by Unitika Ltd., “NeoRez R-966” and “NeoRez R-4000” manufactured by DSM Japan K.K., and “AQUACER507” manufactured by BYK-Chemie Japan K.K. (all product names).

The resin particles B preferably include at least one selected from the group consisting of an (oxidized)polyolefin resin, and a polyurethane resin.

The (oxidized)polyolefin resin is more preferably anionic oxidized polyolefin resins. When the resin particles B are constituted by an anionic oxidized polyethylene resin, the whiteness of white images is further improved by using it together with a pretreatment liquid containing an aggregating agent. The reason for this is presumed as follows, although it is not limited to this.

Based on their ionic character, anionic oxidized polyolefin resins cause an aggregation reaction upon contact with an aggregating agent. Since oxidized polyolefin resins are generally highly hydrophobic resins, they tend to orient toward the interface of aqueous inks. Thus, when ink drops of the white ink (W) land on a surface applied with a pretreatment liquid containing an aggregating agent, among the components in the ink, the anionic oxidized polyolefin resin quickly comes into contact with the pretreatment liquid-applied surface and causes an aggregation reaction, thereby forming an aggregation layer. This aggregation layer suppresses penetration of the ink into fabric and increases the amount of ink remaining on the fabric surface, and consequently the whiteness of white images is thought to improve.

The (oxidized)polyolefin resin preferably has a melting point of 125° C. or more. The melting point may be 150° C. or less. When the melting point of the (oxidized)polyolefin resin is 125° C. or more, the whiteness of white images is further improved particularly when a polyester fabric is used as a fabric to be printed. The reason for this is presumed as follows, although it is not limited to this.

When a polyester fabric is used as a fabric to be printed, it is generally dried at 120° C. or less in order to avoid degradation of color due to re-sublimation of the dye used in polyester. It is thought that the use of an (oxidized)polyolefin resin having a melting point higher than the drying temperature makes it easier to maintain the particle shape even on the printed textile item, thereby achieving the effect of improved whiteness due to irregular reflection.

Examples of the (oxidized)polyolefin resin include a polyethylene resin, an oxidized polyethylene resin, a polypropylene resin, and an oxidized polypropylene resin. Among these, a (oxidized)polyethylene resin is preferable because of easy adjustment of the melting point to a favorable value. The (oxidized)polyethylene resin may be a high-density polyethylene resin.

The polyurethane resin preferably has a charge density of 60 μeq/g or more. The polyurethane resin is preferably a carbonate-based urethane resin.

Accordingly, the resin particles B preferably include at least one selected from the group consisting of an anionic oxidized polyolefin resin and a polyurethane resin that has a charge density of 60 μeq/g or more.

The amount (solid content) of the resin particles B in the white ink (W) is preferably 1% by mass or more, and more preferably 2% by mass or more. The amount (solid content) of the resin particles B in the white ink (W) is preferably 15% by mass or less, more preferably 10% by mass or less, and even more preferably 8% by mass or less. The amount (solid content) of the resin particles B in the white ink (W) is preferably, for example, within a range from 1% to 15% by mass, more preferably from 2% to 10% by mass, and even more preferably from 2% to 8% by mass.

The total amount (solid content) of the resin particles A and resin particles B is, relative to the total amount (solid content) of the resin particles in the white ink (W), preferably 50% by mass or more, more preferably 70% by mass or more, even more preferably 90% by mass or more, still more preferably 95% by mass or more, and may be 100% by mass.

In the white ink (W), the amount of the resin particles A is preferably more than that of the resin particles B.

From the viewpoint of further improving the uniformity of white images, the mass ratio of the resin particles A to the resin particles B, “resin particles A/resin particles B”, is preferably 1.2 or more, more preferably 1.5 or more, and even more preferably 1.8 or more. When the mass ratio of the resin particles A to the resin particles B is 2.5 or more, it is easier to further relax irregularities even for a substrate with a large amount of nap, and is easier to further improve the uniformity of white images. The “resin particles A/resin particles B” may be 5 or less, or 3 or less.

The total of the amount of the resin particles A and the amount of the resin particles B in the white ink (W) is preferably equal to or more than the amount of the white pigment. From the viewpoint of further improving the uniformity of white images, the mass ratio of the total of the resin particles A and resin particles B to the white pigment, “(resin particles A+resin particles B)/white pigment”, is preferably 1 or more, and more preferably 1.2 or more. When the mass ratio of the total of the resin particles A and resin particles B to the white pigment, “(resin particles A+ resin particles B)/white pigment”, is 1 or more, it tends to be difficult for the white pigment to enter gaps in resin particles A, the bond between the resin particles A is less affected, and uniformity is more easily further improved. “(Resin particles A+resin particles B)/white pigment” may be 3 or less, and may be 2 or less.

The white ink (W) preferably contains water, and a main solvent may be water.

There are no particular limitations on the water, but water in which ionic components are as minimal as possible is preferred. In particular, from the viewpoint of storage stability of the ink, it is preferable that the amount of polyvalent metal ions, such as calcium, be low. For example, ion exchanged water, distilled water, ultrapure water, or the like may be used as water.

From the viewpoint of adjusting the ink viscosity, water is, relative to the total amount of the white ink (W), preferably contained in an amount from 30% to 70% by mass, more preferably from 35% to 65% by mass, and even more preferably from 40% to 60% by mass.

The white ink (W) preferably contains a water-soluble organic solvent. As the water-soluble organic solvent, an organic compound that is liquid at room temperature and is dissoluble in water can be used, and it is preferable to use a water-soluble organic solvent that mixes uniformly with an equal volume of water at one atmosphere and 20° C. Examples which can be used include lower alcohols such as methanol, ethanol, 1-propanol, isopropanol, 1-butanol, 2-butanol, isobutanol, and 2-methyl-2-propanol; glycols such as ethylene glycol, diethylene glycol, triethylene glycol, tetraethylene glycol, polyethylene glycol, propylene glycol, dipropylene glycol, tripropylene glycol, and polypropylene glycol; glycerols such as glycerol, diglycerol, triglycerol, and polyglycerol; acetins such as monoacetin and diacetin; glycol ethers such as ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether, and tetraethylene glycol diethyl ether; triethanolamine; 1-methyl-2-pyrrolidone; 1,3-dimethyl-2-imidazolidinone; β-thiodiglycol; and sulfolane. The boiling point of the water-soluble organic solvent is preferably 100° C. or more, and more preferably 150° C. or more.

The water-soluble organic solvents may be used alone, or a combination of two or more of the water-soluble organic solvents may be used as long as a single phase is formed with water. The amount of the water-soluble organic solvent in the white ink (W) is preferably within a range of 5% to 50% by mass, and more preferably within a range of 10% to 40% by mass.

The white ink (W) preferably contains a surfactant.

As the surfactant, an anionic surfactant, a cationic surfactant, an amphoteric surfactant, a nonionic surfactant, or a combination thereof can be preferably used, and a nonionic surfactant is more preferable. Either a low-molecular weight surfactant or a high-molecular weight surfactant can be used.

The HLB value of the surfactant is preferably within a range from 5 to 20, and more preferably from 10 to 18.

Examples of the nonionic surfactant include ester-based surfactants such as glycerol fatty acid esters and fatty acid sorbitan esters; ether-based surfactants such as polyoxyethylene alkyl ethers, polyoxyethylene alkylphenyl ethers, and polyoxypropylene alkyl ethers; ether ester-based surfactants such as polyoxyethylene sorbitan fatty acid esters; acetylene-based surfactants; silicone-based surfactants; and fluorine-based surfactants. Among these, an acetylene-based surfactant, such as an acetylene glycol-based surfactant, can be preferably used.

Examples of the acetylene-based surfactants include acetylene glycol-based surfactants, acetylene alcohol-based surfactants, and surfactants having an acetylene group.

Acetylene glycol-based surfactants are glycols having an acetylene group, are preferably glycols having a left-right symmetrical structure with an acetylene group in the center, and may include a structure in which ethylene oxide has been added to an acetylene glycol.

Examples of commercial products of the acetylene-based surfactants include the SURFYNOL series such as SURFYNOL 104E, SURFYNOL 104H, SURFYNOL 420, SURFYNOL 440, SURFYNOL 465, and SURFYNOL 485 manufactured by Evonik Industries AG, and the OLFINE series such as OLFINE E1004, OLFINE E1010, and OLFINE E1020 manufactured by Nissin Chemical Industry Co., Ltd. (all product names).

Examples of the silicone-based surfactants include polyether-modified silicone-based surfactants, alkyl-aralkyl-comodified silicone-based surfactants, and acrylic silicone-based surfactants.

Examples of commercial products of the silicone-based surfactants include SILFACE SAG002 and SILFACE503A manufactured by Nisshin Chemical Industry Co., Ltd. (both product names).

Further examples of other nonionic surfactants include polyoxyethylene alkyl ether-based surfactants such as the EMULGEN series such as EMULGEN 102KG, EMULGEN 103, EMULGEN 104P, EMULGEN 105, EMULGEN 106, EMULGEN 108, EMULGEN 120, EMULGEN 147, EMULGEN 150, EMULGEN 220, EMULGEN 350, EMULGEN 404, EMULGEN 420, EMULGEN 705, EMULGEN 707, EMULGEN 709, EMULGEN 1108, EMULGEN 4085, and EMULGEN 2025G manufactured by Kao Corporation (all product names).

Examples of the anionic surfactant include the EMAL series such as EMAL 0, EMAL 10, EMAL 2F, EMAL 40, and EMAL 20C, the NEOPELEX series such as NEOPELEX GS, NEOPELEX G-15, NEOPELEX G-25, and NEOPELEX G-65, the PELEX series such as PELEX OT-P, PELEX TR, PELEX CS, PELEX TA, PELEX SS-L, and PELEX SS-H, and the DEMOL series such as DEMOL N, DEMOL NL, DEMOL RN, and DEMOL MS, all manufactured by Kao Corporation (all product names).

Examples of the cationic surfactant include the ACETAMIN series such as ACETAMIN 24 and ACETAMIN 86, the QUARTAMIN series such as QUARTAMIN 24P, QUARTAMIN 86P, QUARTAMIN 60W, and QUARTAMIN 86W, and the SANISOL series such as SANISOL C and SANISOL B-50, all manufactured by Kao Corporation (all product names).

Examples of the amphoteric surfactants include the AMPHITOL series such as AMPHITOL 20BS, AMPHITOL 24B, AMPHITOL 86B, AMPHITOL 20YB, and AMPHITOL 20N manufactured by Kao Corporation (all product names).

One type of the above-described surfactants is preferably used alone, and two or more types may be used in combination.

The amount of a surfactant is, relative to the total amount of the white ink (W), preferably within a range 0.01% to 10% by mass, more preferably from 0.1% to 5% by mass, and even more preferably from 0.2% to 3% by mass.

The white ink (W) may contain other components as necessary. Examples of other components include pH adjusters and preservatives.

The method for producing the white ink (W) is not particularly limited, and the white ink (W) can be produced using appropriate conventional methods. For example, the ink can be obtained by using a stirring device such as a three-one motor to disperse all of the components, either in a single batch or in a number of separate batches, and then passing the dispersion through a filtration device such as a membrane filter as desired. More specifically, other components may be mixed together with the white pigment, resin particles A, resin particles B, and water, as necessary. Examples of other components are described as components that the white ink (W) can contain such as surfactants, water-soluble organic solvents, and pigment dispersants. The resin particles A may be used in the form of a water dispersion of the resin particles A. Similarly, the resin particles B may be used in the form of a water dispersion of the resin particles B. The white pigment may be used in the form of a pigment dispersion in which a pigment has been previously dispersed with a pigment dispersant. These components may be mixed in a single batch or in a number of separate batches.

The pH of the white ink (W) is preferably within a range from 7.0 to 10.0, and more preferably from 7.5 to 9.0, from the viewpoint of storage stability of the ink.

The viscosity of the white ink (W) is preferably within a range of 1 to 30 mPa·s at 23° C. from the viewpoint of inkjet jetting characteristics, for example.

### Non-White Inkjet Ink

The non-white ink (C) contains a non-white pigment, and the resin particles C having a film elongation of 500% or more and a resin skeleton different from those of the resin particles A and resin particles B.

The non-white ink (C) contains a non-white pigment as a coloring material.

Examples of the non-white pigment that can be used include organic pigments such as azo pigments, phthalocyanine pigments, polycyclic pigments, and dye lake pigments, and inorganic pigments such as carbon blacks and metal oxides. Examples of azo pigments include soluble azo lake pigments, insoluble azo pigments, and condensed azo pigments.

Examples of phthalocyanine pigments include metal phthalocyanine pigments and metal-free phthalocyanine pigments. Examples of polycyclic pigments include quinacridone-based pigments, perylene-based pigments, perinone-based pigments, isoindoline-based pigments, isoindolinone-based pigments, dioxazine-based pigments, thioindigo-based pigments, anthraquinone-based pigments, quinophthalone-based pigments, metal complex pigments, and diketopyrrolopyrroles (DPP). Examples of carbon blacks include furnace carbon black, lamp black, acetylene black, and channel black. These pigments may be used alone, or a combination of two or more pigments may be used.

From the viewpoint of jetting stability and storage stability, the average particle size of pigment particles in the non-white ink (C), expressed as the volume-based average value in a particle size distribution measured using a dynamic light scattering method, is preferably 300 nm or less, more preferably 200 nm or less, and even more preferably 150 nm or less.

The non-white pigment may be a self-dispersing pigment. A self-dispersing pigment is a pigment in which a hydrophilic functional group has been introduced at the pigment surface using a chemical or physical treatment. The hydrophilic functional group introduced into the self-dispersing pigment is preferably a group that has ionicity, and by charging the pigment surface either anionically or cationically, the pigment particles can be stably dispersed in water by electrostatic repulsion. Preferred anionic functional groups include carboxy groups, sulfo groups, sulfino groups, sulfuric acid ester groups, phosphoric acid groups, phosphoric acid ester groups, phosphorous acid groups, and phosphorous acid ester groups. Preferred cationic functional groups include a quaternary ammonium group and a quaternary phosphonium group.

These hydrophilic functional groups may be bonded directly to the pigment surface, or may be bonded via another atom grouping. Examples of this other atom grouping include, but are not limited to, an alkylene group, a phenylene group, and a naphthylene group. Examples of methods for treating the pigment surface include diazotization treatments, sulfonation treatments, hypochlorous acid treatments, humic acid treatments, and vacuum plasma treatments.

Examples of products that can be used favorably as self-dispersing pigments include the CAB-O-JET series such as CAB-O-JET 200, CAB-O-JET 300, CAB-O-JET 250C, CAB-O-JET 260M, CAB-O-JET 270, CAB-O-JET 450C, and CAB-O-JET 465M manufactured by Cabot Corporation, and BONJET BLACK CW-1, BONJET BLACK CW-2, BONJET BLACK CW-3, and BONJET BLACK CW-4 manufactured by Orient Chemical Industries, Ltd. (all product names).

A microencapsulated pigment in which a pigment has been coated with a resin may also be used as the pigment.

A pigment dispersion containing a non-white pigment that has already been dispersed using a pigment dispersant may be used. Examples of commercial products of pigment dispersions containing a pigment dispersed using a pigment dispersant include the HOSTAJET series manufactured by Clariant AG, and the FUJI SP series manufactured by Fuji Pigment Co., Ltd. A pigment dispersion dispersed with a pigment dispersant described below may be used.

For the pigment, one type may be used alone, and two or more types may be used in combination.

The amount of the pigment of the non-white ink (C) is, relative to the total amount of the non-white ink (C), preferably within a range from 1% to 10% by mass, more preferably from 2% to 8% by mass, and even more preferably from 2% to 6% by mass, from the viewpoint of printing density and ink viscosity.

The non-white ink (C) may contain a pigment dispersant typified by polymeric dispersants and surfactant-type dispersants in order to stably disperse a pigment in an ink.

The pigment dispersant can be selected and used, for example, from those described above for the white ink (W).

When a pigment dispersant is used, the blend amount in the non-white ink (C) varies depending on the type and is not particularly limited, but in general is preferably within a range of 0.005 to 0.5 as a mass ratio of the active component relative to a value of 1 for the pigment.

The non-white ink (C) contains the resin particles C having a film elongation of 500% or more and a resin skeleton different from those of the resin particles A and resin particles B.

The film elongation of the resin particles C may be 600% or more. It may be 1,000% or less and may be 800% or less. The film elongation of the resin particles C may be, for example, within a range of 500% to 1,000%.

The resin particles C preferably are resin particles that are dispersible in an aqueous solvent. It is preferable that the resin particles C can be dispersed in water without being dissolved in water to form an oil-in-water (O/W) type emulsion.

The resin particles C are preferably contained in a dispersed state as resin particles in the non-white ink (C). The resin particles can be blended as a water dispersion of resin particles in the production of the non-white ink (C).

The resin particles C may be any of anionic resin particles, cationic resin particles, nonionic resin particles, or amphoteric resin particles, for example, but are preferably anionic resin particles, nonionic resin particles, or a combination thereof, and more preferably anionic resin particles.

The anionic resin particles may have an anionic functional group of the resin existing at the surface of resin particles as in a self-emulsifying resin. The anionic resin particles may have been subjected to a surface treatment such as adhering an anionic dispersant to resin particle surfaces. Typical examples of anionic functional groups include carboxy groups, sulfo groups, sulfino groups, sulfuric acid ester groups, phosphoric acid groups, phosphoric acid ester groups, phosphorous acid groups, and phosphorous acid ester groups. An example of the anionic dispersing agent is an anionic surfactant.

The non-ionic resin particles may have a non-ionic functional group of the resin existing at the surface of resin particles as in a self-emulsifying resin. The non-ionic resin particles may have been subjected to a surface treatment such as adhering a non-ionic dispersant to resin particle surfaces. Typical examples of non-ionic functional groups include polyoxyalkylene glycol groups, carboxy groups, and hydroxy groups. An example of the non-ionic dispersant is a non-ionic surfactant.

In terms of the type of resin particles C, the use of a resin that forms a transparent coating film is preferred.

Examples of the type of resin particles C include conjugated diene-based resins such as styrene-butadiene copolymers, methyl methacrylate-butadiene copolymers, and vinyl chloride-vinyl acetate copolymers; (meth)acrylic-based resins such as acrylate ester polymers and methacrylate ester polymers, or copolymers of these compounds with styrene or the like; vinyl-based resins such as ethylene-vinyl acetate copolymers, or functional group-modified resins in which a carboxyl group or the like of any of these resins has been modified with a functional group-containing monomer; and resin particles such as melamine resins, urea resins, polyurethane resins, polyester resins, polyolefin resins, silicone resins, polyvinyl butyral resins, and alkyd resins. Resin particles containing one of these resins may be used, and hybrid resin particles may also be used.

For the resin particles C, one type may be used alone, and two or more types may be used in combination.

Commercial examples of the water dispersion of resin particles C include “Mowinyl 6750”, “Mowinyl 6751D”, “Mowinyl 6770”, “Mowinyl 6775” manufactured by Japan Coating Resin Corporation (all product names).

The resin particles (C) preferably contain a (meth)acrylic resin.

As described above, the resin particles C have a resin skeleton different from those of the resin particles A and resin particles B contained in the white ink (W). As an example, when the resin particles A are constituted by a polyurethane resin and the resin particles B are constituted by an (oxidized)polyolefin resin or a polyurethane resin, the resin particles C are preferably constituted by a (meth)acrylic resin.

Since the resin particles C have a resin skeleton different from those of the resin particles A and resin particles B, miscibility can be suppressed on the surface of a substrate. Further, when the resin particles C have a resin skeleton which is relatively flexible but harder than that of the resin particles A, it is possible to easily return to the original film thickness after stretching while obtaining followability to the stretching of a white image, thereby further improving the color development. From this viewpoint, it is preferable that the resin particles C be a (meth)acrylic resin, and the resin particles A and the resin particles B each be a urethane resin, a polyolefin resin, or a polyester resin. In another example, it is preferable that the resin particles C be a (meth)acrylic resin, the resin particles A be a urethane resin, and the resin particles B be a urethane resin, a polyolefin resin, or a polyester resin. By using a urethane resin for the resin particles A having a high film elongation, it is possible to enhance the followability to fabric substrates, suppress cracks in images, and enhance the color development of non-white images.

The amount (solid content) of the resin particles C in the non-white ink (C) is preferably 3% by mass or more, and more preferably 5% by mass or more. The amount (solid content) of the resin particles C in the non-white ink (C) is preferably 25% by mass or less, more preferably 20% by mass or less, and even more preferably 15% by mass or less. The amount (solid content) of the resin particles C in the non-white ink (C) is preferably, for example, within a range from 3% to 25% by mass, and more preferably from 5% to 20% by mass.

The non-white ink (C) may contain resin particles D other than the resin particles C. The resin particles D preferably have the same resin skeleton as that of the resin particles A.

The resin particles D preferably are resin particles that are dispersible in an aqueous solvent. It is preferable the resin particles D can be dispersed in water without being dissolved in water to form an oil-in-water (O/W) emulsion.

The resin particles D are preferably contained in a dispersed state as resin particles in the non-white ink (C). The resin particles can be blended as a water dispersion of resin particles in the production of the non-white ink (C).

The resin particles D may be any of anionic resin particles, cationic resin particles, nonionic resin particles, or amphoteric resin particles, for example, but are preferably anionic resin particles, nonionic resin particles, or a combination thereof, and more preferably anionic resin particles.

The anionic resin particles may have an anionic functional group of the resin existing at resin particle surfaces as in a self-emulsifying resin. The anionic resin particles may have been subjected to a surface treatment such as adhering an anionic dispersant to resin particle surfaces. Typical examples of anionic functional groups include carboxy groups, sulfo groups, sulfino groups, sulfuric acid ester groups, phosphoric acid groups, phosphoric acid ester groups, phosphorous acid groups, and phosphorous acid ester groups. An example of the anionic dispersing agent is an anionic surfactant.

The non-ionic resin particles may have a non-ionic functional group of the resin existing at resin particle surfaces as in a self-emulsifying resin. The non-ionic resin particles may have been subjected to a surface treatment such as adhering a non-ionic dispersant to resin particle surfaces. Typical examples of non-ionic functional groups include polyoxyalkylene glycol groups, carboxy groups, and hydroxy groups. An example of the non-ionic dispersant is a non-ionic surfactant.

The film elongation of the resin particles D is preferably 1,000% or more, and more preferably 1,200% or more. The film elongation of the resin particles D may be 2,000% or less, and may be 1,700% or less.

In terms of the type of resin particles D, the use of a resin that forms a transparent coating film is preferred.

Examples of the type of resin particles D include conjugated diene-based resins such as styrene-butadiene copolymers, methyl methacrylate-butadiene copolymers, and vinyl chloride-vinyl acetate copolymers; acrylic-based resins such as acrylate ester polymers and methacrylate ester polymers, or copolymers of these compounds with styrene or the like; vinyl-based resins such as ethylene-vinyl acetate copolymers, or functional group-modified resins in which a carboxyl group or the like of any of these resins has been modified with a functional group-containing monomer; and resin particles such as melamine resins, urea resins, polyurethane resins, polyester resins, polyolefin resins, silicone resins, polyvinyl butyral resins, and alkyd resins. Resin particles containing one of these resins may be used, and hybrid resin particles may also be used.

For the resin particle D, one type may be used alone, and two or more types may be used in combination.

Commercial examples of the water dispersion of resin particles D include “Impranil DLP”, “Impranil DLP-R”, “Impranil DLV”, “Impranil DLI”, “Impranil 1016”, “Impranil 1116”, “Impranil DLS”, “Impranil DL 1537”, “Impranil DL 1554”, “Impranil DL 1380”, “Impranil LP CGL 105”, “Impranil DLN-SD”, “Impranil LP DSB 1069”, and “Impranil DLN-W50”, manufactured by Sumika Covestro Urethane Co., Ltd., and “SUPERFLEX E2000”, “SUPERFLEX 740”, “SUPERFLEX 500M”, and “SUPERFLEX 300”, manufactured by DKS Co. Ltd. (all product names).

When the non-white ink (C) contains the resin particles D, the amount (solid content) of the resin particles D in the non-white ink (C) is preferably 3% by mass or more, and more preferably 5% by mass or more. The amount (solid content) of the resin particles D in the non-white ink (C) is preferably 25% by mass or less, more preferably 20% by mass or less, and even more preferably 15% by mass or less. The amount (solid content) of the resin particles D in the non-white ink (C) is preferably, for example, within a range from 3% to 25% by mass, and more preferably from 5% to 20% by mass.

When the non-white ink (C) contains the resin particles D, the mass ratio of the resin particles C to the resin particles D, “resin particles C/resin particles D”, is preferably 0.5 or more, and more preferably 0.8 or more. The mass ratio of the resin particles C to the resin particles D is preferably 2 or less, and more preferably 1.5 or less.

The amount (solid content) of the resin particles in the non-white ink (C) is preferably 3% by mass or more, more preferably 5% by mass or more, and particularly preferably 10% by mass or more. The amount (solid content) of the resin particles in the non-white ink (C) is preferably 25% by mass or less, and more preferably 20% by mass or less. The amount (solid content) of the resin particles in the non-white ink (C) is preferably, for example, within a range from 3% to 25% by mass, and more preferably from 5% to 20% by mass.

When the resin particles contained in the non-white ink (C) are the resin particles C and resin particles D, the total amount (solid content) of the resin particles C and resin particles D is preferably 3% by mass or more, and more preferably 5% by mass or more. The total amount (solid content) of the resin particles C and resin particles D in the non-white ink (C) is preferably 25% by mass or less, and more preferably 20% by mass or less. The total amount (solid content) of the resin particles C and resin particles D in the non-white ink (C) is preferably, for example, within a range from 3% to 25% by mass, and more preferably from 5% to 20% by mass.

The non-white ink (C) preferably contains water, and a main solvent may be water.

There are no particular limitations on the water, but water in which ionic components are as minimal as possible is preferred. In particular, from the viewpoint of storage stability of the ink, it is preferable that the amount of polyvalent metal ions, such as calcium, be low. For example, ion exchanged water, distilled water, ultrapure water, or the like may be used as water.

From the viewpoint of adjusting the ink viscosity, water is preferably contained in an amount of 30% to 70% by mass, and more preferably an amount of 35% to 65% by mass, relative to the total amount of the non-white ink (W).

Non-white ink (C) can contain a water-soluble organic solvent. As the water-soluble organic solvent, an organic compound that is liquid at room temperature and is dissoluble in water can be used. It is preferable to use a water-soluble organic solvent that mixes uniformly with an equal volume of water at one atmosphere and 20° C. The boiling point of the water-soluble organic solvent is preferably 100° C. or more, and more preferably 150° C. or more.

The water-soluble organic solvent can be selected, for example, from those described above for the white ink (W).

For the water-soluble organic solvent, one type may be used alone, and two or more types may be used in combination as long as they form a single phase with water.

The amount of the water-soluble organic solvent in the non-white ink (C) is, relative to the total amount of the non-white ink (C), preferably 10% to 50% by mass, and more preferably 20% to 40% by mass.

The non-white ink (C) preferably contains a surfactant.

As the surfactant, an anionic surfactant, a cationic surfactant, an amphoteric surfactant, a nonionic surfactant, or a combination thereof can also be preferably used, but a nonionic surfactant is more preferable. Either a low-molecular weight surfactant or a high-molecular weight surfactant can be used.

The HLB value of the surfactant is preferably within a range from 5 to 20, and more preferably from 10 to 18.

The surfactant can be selected, for example, from those described above for the white ink (W). In particular, an acetylene-based surfactant, such as an acetylene glycol-based surfactant, can be preferably used.

For the surfactant, one type may be used, and two or more types may be used in combination.

The amount of the surfactant is, relative to the total amount of the non-white ink (C), preferably within a range from 0.01% to 10% by mass, more preferably from 0.1% to 5% by mass, and even more preferably from 0.2% to 3% by mass.

The non-white ink (C) may contain other components as necessary. Examples of other components include pH adjusters and preservatives.

The method for producing the white ink (W) is not particularly limited, and the white ink (W) can be produced using appropriate conventional methods. For example, the ink can be obtained by using a stirring device such as a three-one motor to disperse all of the components, either in a single batch or in a number of separate batches, and then passing the dispersion through a filtration device such as a membrane filter as desired. More specifically, other components may be mixed together with the non-white pigment, resin particles C, and water, as necessary. Examples of other components are described as components that the non-white ink (C) can contain such as resin particles D, surfactants, water-soluble organic solvents, and pigment dispersants. Resin particles C may be used in the form of a water dispersion of the resin particles C. Similarly, resin particles D may be used in the form of a water dispersion of the resin particles D. The non-white pigment may be used in the form of a pigment dispersion in which a pigment has been previously dispersed with a pigment dispersant. These components may be mixed in a single batch or in a number of separate batches.

The pH of the non-white ink (C) is preferably within a range from 7.0 to 10.0, and more preferably from 7.5 to 9.0, from the viewpoint of storage stability of the ink.

The viscosity of the non-white ink (C) is preferably within a range of 1 to 30 mPa·s at 23° C. from the viewpoint of inkjet jetting characteristics, for example.

### Ink Set for Textile Printing

An ink set for textile printing according to one embodiment includes a white ink (W) and a non-white ink (C). The ink set for textile printing may include one or more types of non-white ink (C). The ink set for textile printing may also include a pretreatment liquid containing a polyvalent metal salt, water, and a water-soluble organic solvent. The ink set for textile printing may also include a post-treatment liquid or the like.

A white ink (W) described above may be used as the white ink (W), and a non-white ink (C) described above may be used as the non-white ink (C).

In a case in which the white ink (W) is applied to a fabric and then the non-white ink (C) is applied to the fabric, using this ink set for textile printing, a printed textile item having a non-white image excellent in color development can thus be produced. In particular, when applying the non-white ink (C) in a wet-on-wet manner after applying the white ink (W), a printed textile item having a non-white image excellent in color development can also be produced.

When the ink set for textile printing includes a pretreatment liquid, after the pretreatment liquid is applied to the fabric, the white ink (W) is applied, and the non-white ink (C) is further applied. When the ink set for textile printing according to one embodiment is used, even when each step is in a wet-on-wet method, a printed textile item having a non-white image excellent in color development can be produced.

The pretreatment liquid may contain a polyvalent metal salt.

The polyvalent metal salt may be constituted using a divalent or more polyvalent metal ion and an anion. Examples of the divalent metal ion include Ca²⁺, Mg²⁺, Cu²⁺, Ni²⁺, Zn²⁺, and Ba²⁺. Examples of the anion include Cl⁻, NO³⁻, CH₃COO⁻, I⁻, Br⁻, and ClO₃⁻. Specific examples of the polyvalent metal salt include calcium chloride, calcium nitrate, magnesium nitrate, copper nitrate, calcium acetate, and magnesium acetate.

Only one, or a combination of two or more, of the polyvalent metal salts may be used. The amount of the polyvalent metal salt (active component amount) is, relative to the total amount of the pretreatment liquid, preferably 5% by mass or more, more preferably 10% by mass or more, and even more preferably 15% by mass or more. In contrast, the amount of the polyvalent metal salt (active component amount) is, relative to the total amount of the pretreatment liquid, preferably 40% by mass or less, more preferably 35% by mass or less, and even more preferably 30% by mass or less. The amount of the polyvalent metal salt (amount of active ingredient) is, relative to the total amount of the pretreatment liquid, preferably within a range from 5% to 40% by mass, more preferably from 10% to 35% by mass, and even more preferably from 15% to 30% by mass, for example.

Note that when a metal salt hydrate is used as the polyvalent metal salt, the amount of the polyvalent metal salt (active component amount) is the amount converted to an anhydride.

The pretreatment liquid preferably contains water, and a main solvent may be water.

There are no particular limitations on the water, but water in which ionic components are as minimal as possible is preferred. Examples of the water include ion exchanged water, distilled water, and ultrapure water.

The water is, relative to the total amount of the pretreatment liquid, preferably within a range of 20% to 80% by mass, more preferably of 30% to 70% by mass, and even more preferably of 40% to 60% by mass.

The pretreatment liquid preferably contains a water-soluble organic solvent. As the water-soluble organic solvent, an organic compound that is liquid at room temperature and is dissoluble in water can be used. It is preferable to use a water-soluble organic solvent that mixes uniformly with an equal volume of water at one atmosphere and 20° C. The boiling point of the water-soluble organic solvent is preferably 100° C. or more, and more preferably 150° C. or more. As the water-soluble organic solvent, for example, those described above for the white ink (W) can be used.

For the water-soluble organic solvent, one type may be used alone, and two or more types may be used in combination as long as they form a single phase with water. The amount of the water-soluble organic solvent is, relative to the total amount of the pretreatment liquid, preferably within a range from 1% to 50% by mass, more preferably from 5% to 40% by mass, and even more preferably from 10% to 30% by mass.

The pretreatment liquid preferably contains a surfactant. As the surfactant, an anionic surfactant, a cationic surfactant, an amphoteric surfactant, a nonionic surfactant, or a combination thereof can be preferably used, and a nonionic surfactant is more preferable. Either a low-molecular weight surfactant or a high-molecular weight surfactant can be used.

The HLB value of the surfactant is preferably within a range from 5 to 20, and more preferably from 10 to 18.

As the surfactant, for example, those described above for the white ink (W) can be used.

One type of surfactant may be used alone, and two or more types may be used in combination.

The amount of the surfactant is, relative to the total amount of the pretreatment liquid, preferably within a range from 0.01% to 10% by mass, more preferably from 0.1% to 5% by mass, and even more preferably from 0.2% to 3% by mass.

The pretreatment liquid may contain other components as necessary. Examples of other components include anti-foaming agents, pH adjusters, antioxidants, and preservatives.

The method for producing the pretreatment liquid is not particularly limited, and the pretreatment liquid can be produced using appropriate conventional methods. For example, the pretreatment liquid can be obtained by using a stirring device such as a three-one motor to disperse all of the components, either in a single batch or in a number of separate batches, and then passing the dispersion through a filtration device such as a membrane filter as desired.

The pH of the pretreatment liquid is preferably within a range of 3 to 9, and more preferably of 4 to 8.

The viscosity of the pretreatment liquid is within a range of 1 to 30 mPa·s at 23° C.

### Method for Producing Printed Textile Item

The method for producing a printed textile item using an ink set for textile printing can include a step of applying a pretreatment liquid to a fabric as necessary (hereinafter also referred to as a “pretreatment liquid application step”), a step of applying, in a wet-on-wet manner using an inkjet method, a white ink (W) to a fabric to which the pretreatment liquid has been applied (hereinafter also referred to as “white ink (W) application step”), and a step of applying, in a wet-on-wet manner using the inkjet method, a non-white ink (C) to the fabric to which the white ink (W) has been applied (hereinafter also referred to as “non-white ink (C) application step”).

Examples of fibers included in the fabric include natural fibers such as cotton, silk, wool, and linen; chemical fibers such as polyester, acrylic, polyurethane, nylon, rayon, cupra, and acetate; and mixed spun fibers of the above fibers. The fabric may be a woven fabric, a knitted fabric, a nonwoven fabric, or the like.

The pretreatment liquid application step will be described below.

The method for applying a pretreatment liquid to a fabric is not particularly limited, and any method such as a spray method using an airbrush, dipping method, pad method, and coating method can be used, and various printing methods such as inkjet printing (inkjet method) and screen printing can be used.

The inkjet method is not particularly limited and may be any of a piezoelectric method, electrostatic method, thermal method, and the like. When an inkjet printer is used, it is preferable to jet a pretreatment liquid or ink droplets from an inkjet head on the basis of a digital signal, and to adhere jetted droplets to a fabric.

The area to which the pretreatment liquid is applied may be an area having the same shape as an image formed with the white ink (W), a wide area including the shape of the image formed with white ink (W), or the entire surface of the fabric.

The application area of the pretreatment liquid, the application area of the white ink (W), and the application area of the non-white ink (C) preferably overlap at least partially.

The amount of the pretreatment liquid applied to the fabric is preferably within a range from 10 to 100 g/m², more preferably from 20 to 75 g/m², and even more preferably from 30 to 50 g/m².

The white ink (W) application step will be described below.

The white ink (W) is preferably applied to a fabric using the inkjet method. The inkjet method is not particularly limited and may be any of a piezoelectric method, electrostatic method, thermal method, and the like. When an inkjet printer is used, it is preferable to jet a pretreatment liquid or ink droplets from an inkjet head on the basis of a digital signal, and to adhere jetted droplets to a fabric.

The white ink (W) is preferably applied in such a manner that the application area overlaps at least partially with the application area of the pretreatment liquid. The application area of the pretreatment liquid and the application area of the white ink (W) preferably overlap at least partially.

The white ink (W) is preferably applied, in a wet-on-wet manner, to the fabric to which the pretreatment liquid has been applied. The white ink (W) is preferably applied in a state in which moisture is not completely removed from the fabric to which the pretreatment liquid has been applied. Preferably, the white ink (W) can be applied in a state where the fabric to which the pretreatment liquid has been applied remains wet. For example, after the pretreatment liquid has been applied to the fabric, the white ink (W) is preferably applied to the fabric without performing a drying step such as heat drying. The temperature of the fabric surface after the pretreatment liquid has been applied until the application of the white ink (W) is preferably 40° C. or less, and more preferably 35° C. or less. After the pretreatment liquid has been applied, the white ink (W) is preferably applied in a state where the remaining amount of the volatile component of the pretreatment liquid on the fabric is 90% by mass or more. The time from the application of the pretreatment liquid to the fabric to the application of the white ink (W) is preferably within a range of 0.1 to 200 seconds.

The amount of the white ink (W) applied to the fabric is not particularly limited, but for example, is preferably within a range of 50 to 400 g/m², and more preferably of 100 to 200 g/m².

The non-white ink (C) application step will be described below.

The non-white ink (C) is preferably applied to the fabric using the inkjet method. The inkjet method is not particularly limited and may be any of a piezoelectric method, electrostatic method, thermal method, and the like. When an inkjet printer is used, it is preferable to jet a pretreatment liquid or ink droplets from an inkjet head on the basis of a digital signal, and to adhere jetted droplets to a fabric.

The non-white ink (C) is preferably applied in such a manner that the application area overlaps at least partially with the application area of the white ink (W). The application area of the pretreatment liquid, the application area of the white ink (W), and the application area of the non-white ink (C) preferably overlap at least partially.

The non-white ink (C) is preferably applied, in a wet-on-wet manner, to the fabric to which the white ink (W) has been applied. The non-white ink (C) is preferably applied in a state where moisture is not completely removed from the fabric to which the white ink (W) has been applied. Preferably, the non-white ink (C) can be applied in a state where the fabric to which the white ink (W) has been applied remains wet. For example, after the white ink (W) has been applied to the fabric, the non-white ink (C) is preferably applied to the fabric without performing a drying step such as heat drying. The temperature of the fabric surface after the white ink (W) has been applied until the non-white ink (C) is applied is preferably 40° C. or less, and more preferably 35° C. or less. After the white ink (W) has been applied, the non-white ink (C) is preferably applied in a state where the remaining amount of the volatile component of the white ink (W) on the fabric is 90% by mass or more. The time from the application of the white ink (W) to the fabric to the application of the non-white ink (C) is preferably within a range of 0.1 to 200 seconds.

The amount of the non-white printing ink (C) applied to the fabric is not particularly limited, but for example, is preferably within a range of 5 to 60 g/m², and more preferably of 10 to 30 g/m².

One type of non-white ink (C) may be applied, and two or more types of non-white inks (C) may be applied.

When the pretreatment liquid, white ink (W), and non-white ink (C) are applied using the inkjet method, each application may be performed by using a separate printing apparatus or a single printing apparatus.

For example, application of the pretreatment liquid, application of the white ink (W), and application of the non-white ink (C) may be performed by using a single printing apparatus. For example, by using two printing apparatuses, application of the pretreatment liquid may be performed by using one of the printing apparatuses, and application of the white ink (W) and application of the non-white ink (C) may be performed by using the other of the apparatuses.

After the non-white ink (C) application step, a step of performing a heat treatment on the fabric is preferably provided.

The heat treatment temperature can be appropriately selected depending on the material of the fabric, or the like. The heat treatment temperature is preferably 100° C. or more, and more preferably 150° C. or more. The heat treatment temperature is preferably 200° C. or less from the viewpoint of reducing damage to the fabric.

The heating device is not particularly limited, and for example, a heat press, a roll heater, a hot air device, an infrared lamp heater, or the like can be used.

The heat treatment time may be set appropriately according to the heating method or the like, and is preferably within a range from 1 second to 10 minutes, and may be from 5 seconds to 5 minutes, for example.

After the non-white ink (C) application step, a step of applying a post-treatment liquid may be provided. For example, after the non-white ink (C) application step, a step of performing heat treatment on the fabric may be provided, and then the post-treatment liquid may be applied. For example, after the non-white ink (C) step, the post-treatment liquid may be applied in a wet-on-wet manner. In addition, after the post-treatment liquid is applied, a step of performing heat treatment on the fabric may be provided.

Some embodiments according to the present disclosure are described below.

<1> An ink set for textile printing, including: a white inkjet ink that includes a white pigment, resin particles A which have a film elongation of 1,000% or more, and resin particles B which have a film elongation of less than 1,000% and are ionic resin particles having an average particle size of 150 nm or less; and a non-white inkjet ink that includes a non-white pigment and resin particles C which have a film elongation of 500% or more and a resin skeleton different from those of the resin particles A and the resin particles B.
<2> The ink set for textile printing according to <1>, wherein an amount of resin particles is 10% by weight or more relative to a total amount of the non-white inkjet ink.
<3> The ink set for textile printing according to <1> or <2>, wherein the resin particles A include a polyurethane resin.
<4> The ink set for textile printing according to any one of <1> to <3>, wherein the resin particles B include at least one selected from the group consisting of an anionic oxidized polyethylene resin and a polyurethane resin having a charge density of 60 μeq/g or more.
<5> The ink set for textile printing according to any one of <1> to <4>, wherein the resin particles C include a (meth)acrylic resin.
<6> The ink set for textile printing according to any one of <1> to <5>, wherein the non-white inkjet ink includes resin particles D having the same resin skeleton as that of the resin particles A.
<7> The ink set for textile printing according to <6>, wherein the resin particles D include a polyurethane resin.
<8> The ink set for textile printing according to <6>, wherein the resin particles A include a polyurethane resin, and the resin particles D include a polyurethane resin.

### Examples

Embodiments according to the present invention will be described in detail using examples. The present invention is not limited to the following examples.

In the following description, “%” refers to “% by mass” unless otherwise specified, except for film elongation. In the amounts listed in tables, a raw material blended as a solution or dispersion is indicated as the total amount thereof, and the percentages of the pigment content, resin content, active component, and the like are also indicated.

### 1. Production of Pretreatment Liquid

Table 1 illustrates formulations of pretreatment liquids. Raw materials were mixed at blend ratios described in Table 1 and filtered through a cellulose acetate membrane filter having a pore size of 3 m to obtain pretreatment liquids PT1 and PT2.

Details of the raw materials described in Table 1 are as follows.

### Polyvalent Metal Salt

Magnesium nitrate hexahydrate: manufactured by FUJIFILM Wako Pure Chemical Corporation
Calcium chloride: manufactured by FUJIFILM Wako Pure Chemical Corporation Water-soluble organic solvent
Diethylene glycol: manufactured by FUJIFILM Wako Pure Chemical Corporation Glycerin: manufactured by FUJIFILM Wako Pure Chemical Corporation Surfactant
OLFINE E1020: an acetylene glycol-based surfactant manufactured by Nissin Chemical Industry Co., Ltd.

### [Table 1]

TABLE 1
Formulation of pretreatment liquid

| | | Pretreatment | Pretreatment |
|---|---|---|---|
| Unit: mass % | | liquid PT1 | liquid PT2 |
| Polyvalent metal | Magnesium nitrate | | 51.9 |
| salt | hexahydrate | | |
| | Calcium chloride | 30.0 | |
| Water-soluble | Diethylene glycol | 15.0 | 15.0 |
| solvent | Glycerin | 5.0 | 5.0 |
| Surfactant | OLFINE E1020 | 0.8 | 0.8 |
| Water | Ion exchanged water | 49.2 | 27.3 |

| | | |
|---|---|---|
| Total (mass %) | 100.0 | 100.0 |

### 2. Production of White Inkjet Ink

### (1) Production of White Pigment Dispersion

An amount of 350 g of titanium oxide “R62N” (manufactured by SAKAI CHEMICAL INDUSTRY CO., LTD.) as a white pigment, and 14 g of “DEMOL EP” (manufactured by Kao Corporation; 3.5 g of active component) as a pigment dispersant were used and mixed with 636 g of ion exchanged water, and zirconia beads having a 0.5 mm (D were dispersed using a beads mill (DYNO-MILL KDL A-type, manufactured by SHINMARU ENTERPRISES CORPORATION) with a filling proportion of 80%, and a residence time of 2 minutes, to obtain a white pigment dispersion (pigment content of 35% by mass).

### (2) Production of White Inkjet Ink

Table 2 illustrates formulations of white inkjet inks W1 to W6. Raw materials were mixed at blend ratios described in the table and filtered through a cellulose acetate membrane filter having a pore size of 3 m to obtain the white inks W1 to W6.

Details of the raw materials for the white inkjet inks W1 to W6 in Table 2 are as follows.

### Pigment Dispersion

White pigment dispersion: obtained by using the above method, pigment content of 35% by mass

### Resin Particles A

Dispersion A1: “SUPERFLEX 740”, a water dispersion of polyurethane resin particles, manufactured by DKS Co. Ltd., resin content of 40% by mass, anionic

### Resin Particles B

Dispersion B1: “SUPERFLEX 420”, a water dispersion of polyurethane resin particles, manufactured by DKS Co. Ltd., resin content of 32% by mass, anionic
Dispersion B2: “SUPERFLEX 150HS”, a water dispersion of polyurethane resin particles, manufactured by DKS Co. Ltd., resin content of 30% by mass, anionic
Dispersion B3: “Elitel KT9204”, a water dispersion of polyester resin particles, manufactured by UNITIKA LTD., resin content of 30% by mass, anionic
Dispersion B4: “AQUACER507”, a water dispersion of polyethylene oxide resin, manufactured by BYK-Chemie Japan K.K., resin content of 35% by mass, melting point of resin component 130° C., anionic

### Surfactant

Surfactant 1: “Olfin E1010”, an acetylene glycol-based surfactant, manufactured by Nisshin Chemical Industry Co., Ltd.

### Water-Soluble Organic Solvent

Glycerin: manufactured by FUJIFILM Wako Pure Chemical Corporation
Diethylene glycol: manufactured by FUJIFILM Wako Pure Chemical Corporation

### 3. Production of Non-White Inkjet Ink

Table 3 illustrates the formulations of non-white inkjet inks C1 to C5. Raw materials were mixed at blend ratios described in the table and filtered through a cellulose acetate membrane filter having a pore size of 3 m to obtain the non-white inks C1 to C5.

Details of the raw materials for the non-white inkjet inks C1 to C5 in Table 3 are as follows.

### Pigment Dispersion

Non-white pigment dispersion: “CAB-O-JET465M” manufactured by Cabot Corporation, pigment content of 15% by mass

### Resin Particles C

Dispersion C1: “Mowinyl 6751D”, a water dispersion of acrylic resin particles, manufactured by Japan Coating Resin Corporation, resin content of 50% by mass, anionic
Dispersion C2: “Mowinyl 6750”, a water dispersion of acrylic resin particles, manufactured by Japan Coating Resin Corporation, resin content of 50% by mass, anionic

### Resin Particles D

Dispersion D1: “SUPERFLEX 740”, a water dispersion of polyurethane resin particles, manufactured by DKS Co. Ltd., resin content of 40% by mass, anionic
Dispersion D2: “SUPERFLEX 420”, a water dispersion of polyurethane resin particles, manufactured by DKS Co. Ltd., resin content of 32% by mass, anionic

### Surfactant

Surfactant 1: “Olfin E1010”, an acetylene glycol-based surfactant, manufactured by Nissin Chemical Industry Co., Ltd.

### Water-Soluble Organic Solvent

Glycerin: manufactured by FUJIFILM Wako Pure Chemical Corporation
Diethylene glycol: manufactured by FUJIFILM Wako Pure Chemical Corporation

### 4. Measurement of Film Elongation of Resin Particles

Tables 2 and 3 described the film elongation of resin particles of resin particle dispersions used in the white inkjet inks W1 to W6 and the non-white inkjet inks C1 to C5, excluding dispersions B3 and B4. The film elongation of resin particles described in the table is obtained through the following procedure.

First, each of the water dispersions of resin particles was coated on a polytetrafluoroethylene sheet in such a manner that the film thickness after drying was 500 m, and dried at 23° C. for 15 hours, at 80° C. for 6 hours, and at 120° C. for 20 minutes, and then the resulting film is peeled off from the sheet to prepare a resin film. The resin film was cut into columns with a width of 2 cm and a length of 4 cm to form a resin film specimen. Using a Tensilon Universal Tester RTC-1225A (manufactured by Orientec Co., Ltd.), the resin film specimen was stretched at a measurement temperature of 20° C. and a measurement speed of 200 mm/min, the length until the resin film specimen broke was measured, and a value expressed as a percentage of the length relative to the original length was set as the film elongation.

### 5. Measurement of Average Particle Size of Resin Particles

Table 2 illustrates the average particle size of resin particles of each resin particle dispersion used for the white inkjet inks W1 to W6. The average particle size of resin particles described in the table is the median diameter based on a volume basis measured at a temperature of 25° C. using a dynamic light scattering type particle size distribution measuring device “nanoparticle analyzer nano Partica SZ-100” (manufactured by Horiba, Ltd.), where each of the water dispersions of resin particles is diluted with purified water to a particle concentration of 0.5% by mass, with a dispersion medium refractive index of 1.333, a sample refractive index of 1.600, and a calculation condition of a polydispersity/narrow setting.

### 6. Measurement of Charge Density of Resin Particles

Table 2 illustrates the charge density of resin particles of each resin particle dispersion used for the white inkjet inks W1 to W6, excluding the dispersion B4. The charge density of resin particles described in the table is a value obtained through the following procedure using a streaming potential method. A colloidal particle charge meter (manufactured by AFG ANALYTIC GmbH, Model CAS) was used to measure the charge density. The water dispersion of resin particles to be measured was diluted 100 fold with ion exchanged water, titration was performed with a 0.0025 N poly(diallyldimethylammonium chloride) solution (manufactured by FUJIFILM Wako Pure Chemical Corporation), a reaction end point at which the flow potential of the sample reached 0 V was measured, and the total amount of charge for the sample (water dispersion of diluted resin particles) was determined from the amount of the 0.0025 N poly(diallyldimethylammonium chloride) solution used in reaching this reaction end point. The value obtained by dividing the total amount of charge for the sample (water dispersion of diluted resin particles) by the solid content of the resin particles contained in the sample is the charge density of the resin particles (eq/g).

### [Table 2]

TABLE 2
Formulation of white inkjet ink

| (Unit: mass %) | | | | | | | | | | | |
|---|---|---|---|---|---|---|---|---|---|---|---|
| | | | | Average | | | | | | | |
| | | | Film | particle | Charge | | | | | | |
| | | Resin/ | elongation | size of | density of | | | | | | |
| | | pigment | of resin | resin | resin | | | | | | |
| | | amount | particles | particles | particles | White inkjet ink | | | | | |
| Raw materials | | [%] | [%] | [nm] | [μeq/g] | W1 | W2 | W3 | W4 | W5 | W6 |
| White pigment | | 35 | | | | 28.6 | 28.6 | 28.6 | 28.6 | 28.6 | 28.6 |
| dispersion | | | | | | | | | | | |
| Resin | Dispersion | 40 | 1300 | 170 | 69 | 25.0 | 25.0 | 30.0 | 25.0 | 37.5 | |
| particles A | A1 | | | | | | | | | | |
| Resin | Dispersion | 32 | 290 | 73 | 101 | 15.6 | | | | | 46.9 |
| particles B | B1 | | | | | | | | | | |
| | Dispersion | 30 | 480 | 83 | 85 | | 16.7 | | | | |
| | B2 | | | | | | | | | | |
| | Dispersion | 35 | — | 70 | 57 | | | | 14.3 | | |
| | B3 | | | | | | | | | | |
| | Dispersion | 35 | — | 51 | — | | | 8.6 | | | |
| | B4 | | | | | | | | | | |

| Surfactant | Surfactant 1 | 1.0 | 1.0 | 1.0 | 1.0 | 1.0 | 1.0 |
|---|---|---|---|---|---|---|---|
| Water- | Glycerin | 10.0 | 10.0 | 10.0 | 10.0 | 10.0 | 10.0 |
| soluble | Diethylene glycol | 10.0 | 10.0 | 10.0 | 10.0 | 10.0 | 10.0 |
| solvent | | | | | | | |
| Water | Ion exchanged water | 9.8 | 8.8 | 11.9 | 11.1 | 12.9 | 3.6 |

| | | | | | | |
|---|---|---|---|---|---|---|
| Total (mass %) | 100.0 | 100.0 | 100.0 | 100.0 | 100.0 | 100.0 |
| Pigment amount in ink (mass %) | 10.0 | 10.0 | 10.0 | 10.0 | 10.0 | 10.0 |
| Solid content of resin in ink (mass %) | 15.0 | 15.0 | 15.0 | 15.0 | 15.0 | 15.0 |
| Solid content of resin particles A in ink (mass %) | 10.0 | 10.0 | 12.0 | 10.0 | 15.0 | 0.0 |
| Solid content of resin particles B in ink (mass %) | 5.0 | 5.0 | 3.0 | 5.0 | 0.0 | 15.0 |
| (Average particle size of resin particles A)/(average particle size of | 2.3 | 2.0 | 3.3 | 2.4 | — | — |
| resin particles B) | | | | | | |
| Mass ratio (resin particles A/resin particles B) | 2 | 2 | 4 | 2 | — | — |
| Mass ratio [(resin particles A + resin particles B)/pigment] | 1.5 | 1.5 | 1.5 | 1.5 | — | — |

### [Table 3]

TABLE 3
Formation of non-white inkjet ink

| (Unit: mass %) | | | | | | | | |
|---|---|---|---|---|---|---|---|---|
| | | | Film | | | | | |
| | | Resin/ | elongation | | | | | |
| | | pigment | of resin | | | | | |
| | | amount | particles | Non-white inkjet ink | | | | |
| Raw materials | | [%] | [%] | C1 | C2 | C3 | C4 | C5 |
| Non-white pigment | | 15 | | 26.7 | 26.7 | 26.7 | 26.7 | 26.7 |
| dispersion | | | | | | | | |
| Resin | Dispersion | 50 | 725 | 16.0 | 16.0 | | | |
| particles C | C1 | | | | | | | |
| | Dispersion | 50 | 683 | | | 16.0 | | |
| | C2 | | | | | | | |
| Resin | Dispersion | 40 | 1300 | | 20.0 | | 20.0 | |
| particles D | D1 | | | | | | | |
| | Dispersion | 32 | 319 | | | | | 25.0 |
| | D2 | | | | | | | |

| Surfactant | Surfactant 1 | 0.5 | 0.5 | 0.5 | 0.5 | 0.5 |
|---|---|---|---|---|---|---|
| Water- | Glycerin | 10.0 | 10.0 | 10.0 | 10.0 | 10.0 |
| soluble | Diethylene glycol | 20.0 | 20.0 | 20.0 | 20.0 | 20.0 |
| solvent | | | | | | |
| Water | Ion exchanged water | 26.8 | 6.8 | 26.8 | 22.8 | 17.8 |

| | | | | | |
|---|---|---|---|---|---|
| Total (mass %) | 100.0 | 100.0 | 100.0 | 100.0 | 100.0 |
| Pigment amount in ink [%] | 4.0 | 4.0 | 4.0 | 4.0 | 4.0 |
| Solid content of resin in ink [%] | 8.0 | 16.0 | 8.0 | 8.0 | 8.0 |
| Solid content of resin particles C in ink [%] | 8.0 | 8.0 | 8.0 | 0.0 | 0.0 |
| Solid content of resin particles D in ink [%] | 0.0 | 8.0 | 0.0 | 8.0 | 8.0 |
| Solid content of resin particles in ink [%] | 8.0 | 16.0 | 8.0 | 8.0 | 8.0 |

### 7. Production of Printed Textile Item

Printed textile items of examples 1 to 7 and comparative examples 1 to 4 were produced through the following procedure using the pretreatment liquid, white inkjet ink, and non-white inkjet ink produced above.

Table 4 illustrates types and applying amounts of the pretreatment liquids, white inkjet inks, and non-white inkjet inks used for the production of the printed textile items of examples 1 to 7 and comparative examples 1 to 4.

(1) A black polyester T-shirt manufactured by TOMS Co., Ltd. (product name: Glimmer) was used as a substrate, and a pretreatment liquid was applied to a 10 cm×20 cm area on the surface of the T-shirt using the inkjet method.
(2) After the pretreatment liquid was applied, without a drying step, a white inkjet ink was applied using the inkjet method to the portion to which the pretreatment liquid was applied.
(3) After the white inkjet ink was applied, without a drying step, a non-white inkjet ink was applied using the inkjet method to a half (10 cm×10 cm) of the portion to which the white inkjet ink was applied.
(4) After the non-white inkjet ink was applied, heat drying was performed at 120° C. for 1 minute using a heat press machine manufactured by FUSION, to obtain a printed textile item.

An “MMP-8130” manufactured by Mastermind was used as the printing apparatus for applying the pretreatment liquid, white inkjet ink, and non-white inkjet ink.

### 8. Evaluation of Printed Textile Items

The whiteness of white images and the color development of non-white images of the printed textile items obtained were determined according to the following criteria. The evaluation results are illustrated in Table 4.

### (1) Whiteness of White Images

A: very high whiteness and good uniformity of white images
B: rather low whiteness of white images but good uniformity of white images, or high whiteness of white images but slight irregularity confirmed in white images
C: low whiteness of white images and/or frequent irregularity confirmed in white images

### (2) Color Development of Non-White Images

A: high color development, excellent color reproducibility of ink, and no breakage of non-white images
B: rather low color reproducibility of ink, but high color development and no breakage of non-white images, or high color development and excellent color reproducibility of ink, but slight breakage confirmed in non-white images
C: low color development and poor color reproducibility, and/or frequent breakage confirmed in non-white images
D: low color development and poor color reproducibility, and frequent breakage confirmed in non-white images

### [Table 4]

TABLE 4
Examples

| | | Example 1 | Example 2 | Example 3 | Example 4 | Example 5 | Example 6 |
|---|---|---|---|---|---|---|---|
| Pretreatment | Type | PT1 | PT1 | PT1 | PT2 | PT1 | PT1 |
| liquid | Applying | 100 | 100 | 100 | 100 | 100 | 100 |
| | amount [g/m²] | | | | | | |
| White inkjet | Type | W1 | W1 | W1 | W1 | W2 | W3 |
| ink | Applying | 360 | 360 | 360 | 360 | 360 | 360 |
| | amount [g/m²] | | | | | | |
| Non-white | Type | C1 | C2 | C3 | C1 | C1 | C1 |
| inkjet ink | Applying | 20 | 20 | 20 | 20 | 20 | 20 |
| | amount [g/m²] | | | | | | |

| | | | | | | |
|---|---|---|---|---|---|---|
| Whiteness of white images | A | A | A | A | A | A |
| Color development of | B | A | B | B | B | B |
| non-white images | | | | | | |

| | | | Comparative | Comparative | Comparative | Comparative |
|---|---|---|---|---|---|---|
| | | Example 7 | example 1 | example 2 | example 3 | example 4 |
| Pretreatment | Type | PT1 | PT1 | PT1 | PT1 | PT1 |
| liquid | Applying | 100 | 100 | 100 | 100 | 100 |
| | amount [g/m²] | | | | | |
| White inkjet | Type | W4 | W1 | W1 | W5 | W6 |
| ink | Applying | 360 | 360 | 360 | 360 | 360 |
| | amount [g/m²] | | | | | |
| Non-white | Type | C1 | C4 | C5 | C1 | C1 |
| inkjet ink | Applying | 20 | 20 | 20 | 20 | 20 |
| | amount [g/m²] | | | | | |

| | | | | | |
|---|---|---|---|---|---|
| Whiteness of white images | B | A | A | C | C |
| Color development of | B | C | D | C | C |
| non-white images | | | | | |

The printed textile items of examples 1 to 7 have excellent color development for non-white images. The printed textile items of examples 1 to 7 have excellent whiteness for white images.

In contrast, comparative examples 1 and 2 using non-white inkjet inks C4 and C5 that do not contain the resin particles C have poor color development for non-white images. In particular, since the film elongation of the dispersion D2 used in the non-white inkjet ink C5 is low, frequent breakage in the non-white images was confirmed.

In comparative example 3 using the white inkjet ink W5 without the resin particles B, the color reproducibility of non-white images was low, and the color development was inferior as a result of insufficient filling of the ink. The whiteness of white images was also low, and the black color of the T-shirt could not be sufficiently concealed.

In comparative example 4 using the white inkjet ink W6 without the resin particles A, the non-white image had many broken parts, and the color development was inferior. In addition, the uniformity of the white image was low, and the black color of the T-shirt could not be sufficiently concealed.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An ink set for textile printing, comprising:
a white inkjet ink that includes a white pigment, resin particles A which have a film elongation of 1,000% or more, and resin particles B which have a film elongation of less than 1,000% and are ionic resin particles having an average particle size of 150 nm or less; and
a non-white inkjet ink that includes a non-white pigment and resin particles C which have a film elongation of 500% or more and a resin skeleton different from those of the resin particles A and the resin particles B.

2. The ink set for textile printing according to claim 1, wherein an amount of resin particles is 10% by weight or more relative to a total amount of the non-white inkjet ink.

3. The ink set for textile printing according to claim 1, wherein the resin particles A include a polyurethane resin.

4. The ink set for textile printing according to claim 1, wherein the resin particles B include at least one selected from the group consisting of an anionic oxidized polyethylene resin and a polyurethane resin having a charge density of 60 μeq/g or more.

5. The ink set for textile printing according to claim 1, wherein the resin particles C include a (meth)acrylic resin.

6. The ink set for textile printing according to claim 1 wherein the non-white inkjet ink includes resin particles D having a same resin skeleton as that of the resin particles A.

7. The ink set for textile printing according to claim 6, wherein the resin particles D include a polyurethane resin.

8. The ink set for textile printing according to claim 6, wherein the resin particles A include a polyurethane resin, and the resin particles D include a polyurethane resin.
